(19) United States
(12) Patent Application Publication
(10) Pub. No.: US 2026/0193749 A1
(43) Pub. Date: Jul. 9, 2026

(54) GRAIN-ORIENTED ELECTRICAL STEEL SHEET AND MANUFACTURING METHOD THEREFOR

(71) Applicant: NIPPON STEEL CORPORATION, Tokyo (JP)

(72) Inventors: Masaru TAKAHASHI, Tokyo (JP); Masato YASUDA, Tokyo (JP); Nobusato MORISHIGE, Tokyo (JP); Naoki WADA, Tokyo (JP); Masataka IWAKI, Tokyo (JP); Hisashi MOGI, Tokyo (JP)

(73) Assignee: NIPPON STEEL CORPORATION, Tokyo (JP)

(21) Appl. No.: 19/130,866

(22) PCT Filed: Nov. 22, 2023
(86) PCT No.: PCT/JP2023/042040

§ 371 Date: May 16, 2025

(30) Foreign Application Priority Data
Nov. 22, 2022 (JP) 2022-186166

(51) Int. Cl. C22C 38/02; C21D 6/00; C21D 8/1216; C21D 8/1244; C21D 8/1277; C21D 9/46; C21D 10/00

(52) U.S. Cl. CPC C22C 38/02; C21D 6/008; C21D 8/1222; C21D 8/1233; C21D 8/1255; C21D 8/1272; C21D 8/1283; C21D 9/46; C21D 10/00; C21D 2201/05

(57) ABSTRACT

A grain-oriented electrical steel sheet includes: a silicon steel sheet; an oxide layer formed of one or more kinds of Mg, Al, and Si that is formed on a surface of the silicon steel sheet; and an insulating coating layer that is formed on a surface of the oxide layer, in which an oxide of one or more kinds of Mg, Al, and Si having an equivalent circle diameter of 0.1 to 3.0 μm is present at a density of 0.010 to 0.200 grains/μm² in the silicon steel sheet in a range of 5 μm in a sheet thickness direction from an interface between the silicon steel sheet and the oxide layer, flat grains are present on the surface side of the silicon steel sheet, in a cross section in the sheet thickness direction, a length of grain boundaries of the flat grains accounts for 50% or more of a length of the interface between the silicon steel sheet and the oxide layer, and a plurality of linear thermal strains extending in a direction having an angle of 80 to 100° with respect to a rolling direction are formed on the surface of the silicon steel sheet at intervals of 1.0 to 20.0 mm in the rolling direction.

### TECHNICAL FIELD

The present invention relates to a grain-oriented electrical steel sheet and a manufacturing method therefor.

Priority is claimed on Japanese Patent Application No. 2022-186166, filed Nov. 22, 2022, the content of which is incorporated herein by reference.

### BACKGROUND ART

A grain-oriented electrical steel sheet is a soft magnetic material, and is mainly used as a core material of a transformer. The grain-oriented electrical steel sheet is a steel sheet in which, for example, 2.00 to 6.00% of Si is contained and the crystal orientation of the product is highly integrated in a {110}<001> orientation. As the magnetic characteristics, the grain-oriented electrical steel sheet is required to have a high magnetic flux density represented by B8 value and a low iron loss represented by W17/50. In particular, recently, from the viewpoint of energy saving, a demand for a reduction in power loss of a transformer has increased, and a demand for a reduction in iron loss of the grain-oriented electrical steel sheet has increased.

Iron loss can be roughly classified into two iron loss components including hysteresis loss and eddy current loss. Further, eddy current loss can be classified into classical eddy current loss and anomalous eddy current loss.

For example, in order to reduce classical eddy current loss, a method of increasing the electric resistance of the grain-oriented electrical steel sheet and a method of reducing the thickness of a silicon steel sheet as a base steel sheet are known.

However, in these methods, the productivity decreases, which is not preferable. In addition, only with these countermeasures, the iron loss improvement effect cannot be sufficiently obtained.

In order to reduce hysteresis loss, it is important to increase the magnetic flux density, and it is effective to control a crystal orientation in the steel sheet to an orientation close to Goss orientation through cold rolling or a control of an inhibitor.

For example, Patent Document 1 describes that, by forming an oxide layer that is rich in silica by decarburization annealing, the decomposition and disappearance of the inhibitor is suppressed, and recrystallization of grains having a crystal orientation close to Goss orientation (hereinafter, referred to as Goss orientation grains) can be stably caused to occur.

With the above-described method, although the magnetic flux density is improved, the number of Goss orientation grains to be recrystallized is reduced, and thus the number of Goss orientation grains per unit area of the steel sheet is reduced. That is, the grain size per Goss orientation grain further increases. As a result, the magnetic domain width of 180° magnetic domains (hereinafter, referred to as magnetic domain widths) that are formed in the Goss orientation grains and contribute to magnetic characteristics of the grain-oriented electrical steel sheet increases. In this case, even when hysteresis loss is reduced by improving the improvement of the magnetic flux density, anomalous eddy current loss increases due to an increase in magnetic domain width. As a result, iron loss is canceled out, and the iron loss reduction effect corresponding to the improvement of the magnetic flux density cannot be obtained.

Therefore, disclosed is a method of reducing anomalous eddy current loss by reducing the magnetic domain width while exhibiting the effect of reducing hysteresis loss by the magnetic flux density improvement. One usual method is a method of periodically imparting thermal strain in a rolling direction of the grain-oriented electrical steel sheet surface, and a high energy source such as a laser or an electron beam is used.

For example, Patent Document 2 discloses a method for manufacturing a grain-oriented electrical steel sheet whose magnetic domains are controlled by laser beam irradiation, including: a step of irradiating a surface of a grain-oriented electrical steel sheet with a focused continuous wave laser beam while scanning the grain-oriented electrical steel sheet from a rolling direction toward an inclination direction thereof; and a step of repeating the laser irradiation while shifting scanning portions of the continuous wave laser beam at a predetermined interval, when an average irradiation energy density Ua is defined as Ua=P/(Vc×PL) (mJ/mm²), where P(W) represents the average power of the continuous wave laser beam, Vc (mm/s) represents the speed of the scanning, and PL (mm) represents the predetermined interval, 1.0 mm≤PL≤3.0 mm and 0.8 mJ/mm²≤Ua≤2.0 mJ/mm² are satisfied.

Patent Document 2 discloses that, while easily ensuring high productivity, iron loss in both of the rolling direction and the width direction of the grain-oriented electrical steel sheet can be reduced.

In addition, Patent Document 3 discloses a method for manufacturing a grain-oriented electrical steel sheet having improved iron loss characteristics by forming linear closure domains substantially perpendicular to a rolling direction of the steel sheet and at a substantially constant interval by scanning irradiation of a continuous wave laser beam.

In Patent Document 3, the laser is of a TEM00 mode with an intensity profile of the laser beam in a cross section perpendicular to a direction of beam propagation having a maximum intensity near the center of an optical axis, and a focused beam diameter d [mm] in the rolling direction, a linear scanning speed V [mm/s] of the laser beam, and an average output P [W] of the laser is in a range of 0<d≤0.2 and 0.001≤P/V≤0.012. As a result, the grain-oriented electrical steel sheet with reduced iron loss can be obtained.

In order to reduce iron loss, in addition to the above-described improvement of the magnetic flux density technique, improvements of the magnetic domain control technique corresponding thereto are required. However, recently, the development of the magnetic domain control technique cannot catch up with the development of the magnetic flux density improvement technique, and there is a problem in that the iron loss reduction corresponding to the magnetic flux density improvement technique cannot be sufficiently achieved.

### CITATION LIST

### Patent Document

Patent Document 1: Japanese Unexamined Patent Application, First Publication No. S62-151522
Patent Document 2: Japanese Patent No. 4669565
Patent Document 3: Japanese Patent No. 4510757

### SUMMARY OF INVENTION

### Technical Problem

As described above, it has been considered to improve magnetic flux density and to obtain the iron loss reduction effect corresponding to a degree of the improvement, but cannot also sufficiently meet the demand that has been increasing in recent years. Regarding the so-called thermal strain-imparted magnetic domain control material (hereinafter, simply referred to as the magnetic domain control material) that is mainly suitable for a laminated core and where the grain-oriented electrical steel sheet is irradiated with a laser, an electron beam, a plasma, or the like to intentionally impart thermal strain such that the magnetic domain width is reduced and the iron loss is reduced, the effect is also not sufficient, and studies have been conducted on possibility for iron loss reduction.

Therefore, an object of the present invention is to provide a grain-oriented electrical steel sheet having excellent magnetic characteristics, that is, a high magnetic flux density and low iron loss corresponding to the magnetic flux density, in the magnetic domain control material, and a manufacturing method therefor.

### Solution to Problem

The present inventors investigated improvement of magnetic characteristics of a magnetic domain control material of a grain-oriented electrical steel sheet that is mainly suitable for application to a laminated core, that is, improvement of a magnetic flux density and iron loss reduction. As a result, the following can be seen. By forming grains (hereinafter, “flat grains”) where a deviation angle of a crystal orientation from Goss orientation ({110}<001> orientation) is 10° or more on a surface side of a silicon steel sheet (base steel sheet) in the grain-oriented electrical steel sheet, the 180° magnetic domain width can be controlled to be small in terms of energy. Therefore, even when thermal strain is imparted as in the related art, the eddy current loss and the iron loss can be further reduced as compared to the related art, and thus the iron loss can be further reduced.

In addition, the present inventors investigated the effect of manufacturing conditions. As a result, the following findings were obtained regarding the following points.

That is, Goss orientation where high magnetic characteristics are exhibited in the grain-oriented electrical steel sheet are highly integrated by allowing AlN, MnS, or the like called an inhibitor to be present as a precipitate in a grain boundary in a finish annealing step as a manufacturing step and exhibiting an abnormal grain growth phenomenon called “secondary recrystallization” utilizing the pinning effect of the precipitate. After completing the integration of Goss orientation in the steel sheet, that is, after covering the inside of the sheet surface with Goss orientation grains, the inhibitor of which the function ends is decomposed and oxidized by a temperature increase in the latter half of a finish annealing step and is removed from the inside of the steel sheet. That is, the decomposition and oxidation of the inhibitor before sufficient integration of Goss orientation in the steel sheet is not preferable. Further, by suppressing the decomposition and oxidation of the inhibitor at a higher temperature, Goss orientation can be highly integrated, that is, crystals having an orientation closer to ideal Goss orientation can be integrated. To that end, a method of improving the heat resistance of the precipitate which acts as the inhibitor is used.

The present inventors found that, as the method of improving the heat resistance of the inhibitor, it is effective to allow an oxide that can suppress the decomposition and oxidation of the inhibitor during subsequent finish annealing to be present on the sheet surface in a decarburization annealing step that is typically performed during the manufacturing of the grain-oriented electrical steel sheet. Further, it was found that, by allowing the oxide that can suppress the decomposition and oxidation of the above-described inhibitor to be present on the sheet surface using the decarburization annealing step before finish annealing, the flat grains can be formed in the vicinity of the interface between the oxide of the sheet surface and the steel sheet.

In addition, the present inventors found that, in order to form more preferable flat grains for improving magnetic characteristics, it is effective to form the oxide grains more densely, thick, and uniformly on the surface side of the cold rolled sheet for forming the base steel sheet in the decarburization annealing step, and in order to form the oxide grains densely, thick, and uniformly, it is effective to grind, before the decarburization annealing step, the cold rolled sheet under predetermined conditions for removing a reactant with the surface of the steel sheet that inhibits the uniform oxidation of the sheet surface during decarburization annealing.

In addition, the grain-oriented electrical steel sheet may be irradiated with a laser, an electron beam, a plasma, or the like to intentionally impart thermal strain for magnetic domain control. In the above-described grain-oriented electrical steel sheet, the magnetic domain width is small before performing the magnetic domain control. Therefore, it was found that, by combining these techniques, excellent magnetic characteristics, that is, high magnetic flux density and iron loss reduction can be achieved due to the synergistic effect.

The present invention has been made in view of the above findings. The gist of the present invention is as follows.

[1] According to one aspect of the present invention, there is provided a grain-oriented electrical steel sheet including: a silicon steel sheet; an oxide layer formed of one or more kinds of Mg, Al, and Si that is formed on a surface of the silicon steel sheet; and an insulating coating layer that is formed on a surface of the oxide layer, in which an oxide of one or more kinds of Mg, Al, and Si having an equivalent circle diameter of 0.1 to 3.0 μm is present at a density of 0.010 to 0.200 grains/μm² in a range of 5 μm in a sheet thickness direction from an interface between the silicon steel sheet and the oxide layer in the silicon steel sheet, on the surface side of the silicon steel sheet, flat grains where an average thickness in a direction perpendicular to the surface is 0.5 to 5.0 μm, an aspect ratio that is a ratio of a grain width in a direction parallel to the surface to the average thickness is 1.5 or more, and a deviation of a crystal orientation from Goss orientation is 10° or more are present, in a cross section in the sheet thickness direction, a length of grain boundaries of the flat grains accounts for 50% or more of a length of the interface between the silicon steel sheet and the oxide layer, and a plurality of linear thermal strains extending in a direction having an angle of 80 to 100° with respect to a rolling direction are formed on the surface of the silicon steel sheet at intervals of 1.0 to 20.0 mm in the rolling direction.

[2] In the grain-oriented electrical steel sheet according to [1], an average of the average thicknesses of the flat grains may be 0.5 to 2.0 μm.

[3] In the grain-oriented electrical steel sheet according to [1] or [2], a coverage of the oxide layer on surfaces of the flat grains forming the interface may be 50% or more.

[4] According to another aspect of the present invention, there is provided a manufacturing method for a grain-oriented electrical steel sheet, the manufacturing method including: a hot rolling step of heating and hot rolling a slab to obtain a hot rolled sheet; a hot rolled sheet annealing step of annealing the hot rolled sheet after the hot rolling step; a pickling step of pickling the hot rolled sheet after the hot rolled sheet annealing step; a cold rolling step of cold rolling the hot rolled sheet after the pickling step to obtain a cold rolled sheet; a grinding step of grinding a surface of the cold rolled sheet after the cold rolling step; a contact step of bringing the cold rolled sheet after the grinding step into contact with an aqueous solution of pH 4.0 to 10.0; a decarburization annealing step of performing decarburization annealing on the cold rolled sheet after the contact step; a finish annealing step of applying an annealing separator to the cold rolled sheet after the decarburization annealing step and subsequently performing finish annealing to form an oxide layer formed of one or more kinds of Mg, Al, and Si on a surface of the cold rolled sheet that is a base steel sheet; an insulating coating forming step of forming an insulating coating layer on a surface of the oxide layer after the finish annealing step to obtain a grain-oriented electrical steel sheet including the silicon steel sheet, the oxide layer, and the insulating coating layer; and a magnetic domain control step of irradiating a surface of the grain-oriented electrical steel sheet after the insulating coating forming step with a laser, an electron beam, or a plasma to form a plurality of linear thermal strains extending in a direction having an angle of 80 to 100° with respect to a rolling direction on the surface of the silicon steel sheet such that each of intervals in the rolling direction is 1.0 to 20.0 mm, in which in the grinding step, using abrasive grains having a Knoop hardness of 1000 or more or using abrasive paper, a roll, or a brush to which the abrasive grains are fixed, the surface of the cold rolled sheet is ground such that the amount of abrasion on at least one surface of the cold rolled sheet is 0.10 to 3.00 g/m².

### Advantageous Effects of Invention

According to the above-described aspects of the present invention, a grain-oriented electrical steel sheet having excellent magnetic characteristics and a manufacturing method therefor can be provided.

### BRIEF DESCRIPTION OF DRAWINGS

FIG. 1 A schematic diagram illustrating a cross section of a grain-oriented electrical steel sheet according to the present embodiment.

FIG. 2 A diagram illustrating a method for measuring the average thickness and the aspect ratio of a grain.

FIG. 3 A diagram illustrating a method for measuring the coverage of an oxide layer in flat grains.

### DESCRIPTION OF EMBODIMENTS

Hereinafter, a grain-oriented electrical steel sheet according to one embodiment of the present invention (grain-oriented electrical steel sheet according to the present embodiment) and a manufacturing method therefor will be described.

### <Grain-Oriented Electrical Steel Sheet>

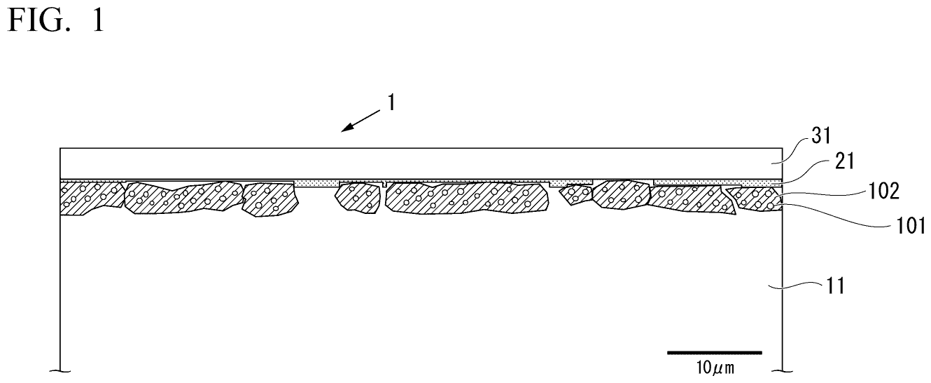

As illustrated in FIG. 1, a grain-oriented electrical steel sheet 1 according to the present embodiment includes: a silicon steel sheet 11 (hereinafter, there is a case that it is called as the base steel sheet or also simply the steel sheet); an oxide layer 21 formed of one or more kinds of Mg, Al, and Si that is formed on a surface of the silicon steel sheet 11; and an insulating coating layer 31 that is formed on a surface of the oxide layer 21.

The oxide layer 21 and the insulating coating layer 31 may be formed on only one surface of the steel sheet but are preferably formed on both surfaces of the steel sheet from the viewpoints of insulation properties and the like. Hereinafter, each of the elements will be described.

### [Silicon Steel Sheet]

(Oxide of one or more kinds of Mg, Al, and Si having an equivalent circle diameter of 0.1 to 3.0 μm are present at a density of 0.010 to 0.200 grains/μm² in a range of 5 μm in a sheet thickness direction from an interface between the silicon steel sheet and the oxide layer)

In the grain-oriented electrical steel sheet, decomposition and oxidation of inhibitors (precipitates present in grain boundaries of AlN or the like) during finish annealing is suppressed, and the inhibitors are allowed to be present at a high temperature. As a result, during secondary recrystallization, Goss orientation can be highly integrated, that is, crystals having a crystal orientation closer to ideal Goss orientation can be integrated, and the magnetic flux density can be improved. Therefore, iron loss can be reduced.

The sizes of the precipitates as the inhibitors are extremely small at several tens of nm to about one hundred of nm in terms of equivalent circle diameter. In addition, there is a distribution in the sizes. When there is a distribution in the sizes, decomposition and oxidation of an inhibitor having a small size is completed at a low temperature, and the effect as the inhibitor is lost. In this case, secondary recrystallization of Goss orientation closer to ideal Goss orientation is difficult, and it is difficult to improve the magnetic flux density. On the other hand, by controlling the size distribution of the inhibitors to be fixed (such that a different between the sizes is reduced), the object can be achieved, which is industrially very difficult.

On the other hand, as long as the inhibitors can be allowed to be present at a high temperature by suppressing decomposition and oxidation using any method even in a state where there is the size distribution of the inhibitors, secondary recrystallization of grains having a crystal orientation closer to ideal Goss orientation can be caused to occur. In addition, in order to suppress the decomposition and oxidation of the inhibitors, a method of using inhibitors having high heat resistance can be used. On the other hand, as a method of achieving the suppression without changing components or the like of the inhibitors, it is known that Si oxide grains (hereinafter, referred to as Si-based pre-oxides) that are formed on the sheet surface or in the steel in the vicinity of the surface in a decarburization annealing step contribute to the suppression. The mechanism is a supposition but is presumed to be that the oxidation of the inhibitors occurs when a small amount of oxygen in a finish annealing atmosphere oxidizes AlN or the like on the sheet surface, and the above-described Si-based pre-oxide prevents and reduces the oxidation.

However, the formation state of the Si-based pre-oxide in each of parts of the surface of the silicon steel sheet is likely to be non-uniform. When the formation state is non-uniform, the effect of suppressing the decomposition and oxidation of the inhibitors varies depending on locations in the steel sheet surface, and the desired effect cannot be sufficiently obtained.

The present inventors investigated the reason why the formation state of the oxide layer after finish annealing is non-uniform at each of the parts of the surface. As a result, it was found that an Fe-based oxide on a surface of the silicon steel sheet (cold rolled sheet) before decarburization annealing or a reactant between an oil-based agent or an extreme pressure additive in a rolling oil used during cold rolling and surface metal of the steel sheet is non-uniformly present on the sheet surface, and the Fe-based oxide or the reactant inhibits the Si-based pre-oxide on the sheet surface from being formed densely, thick, and uniformly in region of a predetermined thickness from the surface during decarburization annealing.

Since it is difficult to uniformly form the Fe-based oxide film or the reactant during cold rolling, the present inventors investigated a configuration of detoxifying a factor of inhibiting the formation of the Si-based pre-oxide. As a result, it was found that, by grinding the surface (at least one surface) of a cold rolled sheet before a decarburization annealing step to a certain degree to expose a clean metal surface using abrasive grains or using abrasive paper, a roll, or a brush to which the abrasive grains are fixed and bringing the cold rolled sheet into contact with an aqueous solution immediately after the grinding, The Fe-based oxide or the reactant that is the factor of inhibiting the formation of the Si-based pre-oxide can be removed from the surface of the steel sheet, and the Si-based pre-oxide can be formed uniformly in the region of the predetermined thickness from the surface of the steel sheet after the decarburization annealing step. Therefore, based on these findings, the magnetic domain control material which is irradiated with a laser, an electron beam, a plasma, or the like was optimized.

Based on the above-described findings, in the grain-oriented electrical steel sheet 1 according to the present embodiment, an oxide (oxide grains 101) of one or more kinds of Mg, Al, and Si having an equivalent circle diameter of 0.1 to 3.0 μm is present at a density of 0.010 to 0.200 grains/μm² in a range of 5 μm in a sheet thickness direction from an interface between the silicon steel sheet 11 and the oxide layer 21. This oxide may be an oxide (including a complex oxide) of one or more kinds of Mg, Al, and Si. Assuming manufacturing conditions described below, the oxide 101 is likely to be an oxide containing Mg, Al, and Si, for example, spinel (MgAl₂O₄), alumina (Al₂O₃), or mullite (2SiO₂·3Al₂O₃).

When the number density of the oxide is excessively small, the adhesion of the oxide layer with the steel sheet deteriorates, and the formation of flat grains described below is non-uniform. On the other hand, when the number density is excessively large, the area of the metal portion in the steel sheet decreases, and thus the magnetic flux density decreases. In addition, the proportion of the flat grains is also relatively small, and thus the effect of reducing iron loss is less likely to be obtained.

By uniformly forming the Si-based pre-oxide in a predetermined region after decarburization annealing, a variation in the sheet surface in the effect of suppressing the decomposition and oxidation of the inhibitors during finish annealing is reduced, and the magnetic flux density is improved in the grain-oriented electrical steel sheet. In addition, by appropriately forming the flat grains, the 180° magnetic domain width is reduced, and the iron loss reduction effect corresponding to high the magnetic flux density is obtained even in the magnetic domain control material.

(On the surface side of the silicon steel sheet, flat grains where an average thickness in a direction perpendicular to the surface is 0.5 to 5.0 μm, an aspect ratio that is a ratio of a grain width in a direction parallel to the surface to the average thickness is 1.5 or more, and a deviation of a crystal orientation from Goss orientation is 10° or more are present)

(In a cross section in the sheet thickness direction, a length of grain boundaries of the flat grains accounts for 50% or more of a length of the interface between the silicon steel sheet and the oxide layer)

As described above, in the grain-oriented electrical steel sheet according to the present embodiment, by uniformly forming the Si-based pre-oxide on a surface layer area (range of 5 μm from the surface) of the silicon steel sheet (base steel sheet) mainly using a decarburization annealing step or the like, the decomposition and oxidation of the inhibitors during finish annealing are suppressed, and the inhibitors are allowed to be present at a high temperature. In this case, Goss orientation can be highly integrated, that is, crystals having a crystal orientation closer to ideal Goss orientation can be integrated, and thus the magnetic flux density is improved. That is, iron loss can be reduced.

On the other hand, the occurrence of secondary recrystallization at a higher temperature represents that secondary recrystallization occurs only for grains having a crystal orientation closer to ideal Goss orientation. In this case, the number of Goss orientation grains to be secondarily recrystallized is reduced, and thus the number of Goss orientation grains per unit area of the steel sheet is reduced. That is, the grain size per Goss orientation grain further increases.

The iron loss required for the grain-oriented electrical steel sheet is classified into hysteresis loss and eddy-current loss as the breakdown. The hysteresis loss is further reduced by improving the magnetic flux density. On the other hand, the eddy-current loss is classified into classical eddy current loss that is reduced by a decrease in sheet thickness and an increase in the specific resistance of the steel sheet and anomalous eddy current loss that is reduced by a decrease in the magnetic domain width formed in Goss orientation grains. The decrease in sheet thickness and the increase in the specific resistance of the steel sheet relating to the classical eddy current loss reduction is likely to affect productivity. Therefore, it is important to reduce the anomalous eddy current loss, that is, to reduce the magnetic domain width. In general, the magnetic domain width has a correlation with the grain size of Goss orientation. In general, by reducing the grain size, the magnetic domain width of the so-called 180° magnetic domain formed in the grain-oriented electrical steel sheet is also reduced.

That is, although the magnetic flux density is improved by controlling the above-described oxide, there is a concern that the anomalous eddy current loss increases due to an increase in grain size such that the iron loss reduction effect corresponding to the improvement of the magnetic flux density cannot be obtained. The same also applies to the magnetic domain control material formed by irradiation with a laser, an electron beam, a plasma, or the like.

Accordingly, the present inventors investigated a method for the iron loss reduction corresponding to the improvement of the magnetic flux density, that is, a method for reducing the anomalous eddy current loss, that is, reducing the magnetic domain width while improving the abundance frequency of ideal Goss orientation grains and assuming the magnetic domain control. As a result, it was found that, even when secondary recrystallization is caused to occur at a higher temperature as described above for only grains having a crystal orientation closer to ideal Goss orientation such that the grain size of the grains increases, by allowing flat grains where a deviation angle from Goss orientation is 10° or more to be present on the surface of the steel sheet, the 180° magnetic domain width can be controlled to be small in terms of energy, and an increase in eddy current loss can be suppressed. This effect is also exhibited in the magnetic domain control material formed by irradiation with a laser, an electron beam, a plasma, or the like. Specifically, as illustrated in FIG. 1, it was found that the eddy current loss is reduced and the effect can be exhibited even after the magnetic domain control when the flat grains 102 where an average thickness in a direction perpendicular to the surface is 0.5 to 5.0 μm, an aspect ratio that is a ratio of a grain width in a direction parallel to the surface to the average thickness is 1.5 or more, and a deviation of a crystal orientation from Goss orientation is 10° or more are present on the surface side of the base steel sheet (silicon steel sheet) 11 (when the flat grains are present as grains forming the outermost layer of the silicon steel sheet).

In the grains where the average thickness is less than 0.5 μm, the aspect ratio is less than 1.5, or the deviation from Goss orientation is less than 10°, the effect of reducing the magnetic domain width cannot be sufficiently obtained, and iron loss cannot be sufficiently reduced.

On the other hand, the grains have the deviation from Goss orientation. Therefore, when the average thickness of the grains is more than 5.0 μm, magnetic characteristics deteriorate as a whole, that is, the magnetic flux density is reduced and iron loss increases.

The average of the average thicknesses of the flat grains is preferably 0.5 to 2.0 μm from the viewpoint that the effect of reducing the magnetic domain width can be sufficiently obtained in the state that the thermal strain is imparted by irradiation with a laser, an electron beam, a plasma or the like where the magnetic domain width can be reduced.

In addition, in order to sufficiently obtain the above-described magnetic domain refinement effect, in a cross section in the sheet thickness direction, the length of grain boundaries of the flat grains accounts for 50% or more of the length of the interface between the base steel sheet and the oxide layer.

When the proportion of the flat grains forming the interface is small, the effect of reducing the magnetic domain width is insufficient, and thus the effect of reducing iron loss cannot be sufficiently obtained.

In the manufacturing method for the grain-oriented electrical steel sheet, during finish annealing, fine Goss orientation grains present on the inner portion in the sheet thickness direction of the steel sheet grow while encroaching on peripheral grains having an orientation other than Goss orientation. As a result, the proportion of the Goss orientation grains (grains when a longitudinal direction of the silicon steel sheet is the <100> direction and a plane direction thereof is the <110> direction) with respect to a rolling direction and a width direction further increases across the sheet thickness surface from the inner portion in the sheet thickness direction.

In the grain-oriented electrical steel sheet according to the present embodiment, by allowing the oxide to be present discretely in the surface layer area of the steel sheet, during the growth of the Goss orientation grains present on the inside in the sheet thickness direction, fine flat grains remain in the steel sheet surface layer area without being encroached by the Goss orientation grains. As a result, it is considered that “the flat grains” that are verified as flat-shaped grains are formed.

The average thickness and the aspect ratio and the deviation of the crystal orientation of the grains present on the surface layer area (range of 5 μm from the interface) of the silicon steel sheet can be measured using the following method.

For example, a sample having a 20 mm square is cut from the steel sheet such that a surface parallel to the rolling direction (RD direction) is obtained as a cross section, and the sample is polished such that the cross section is a mirror surface. In addition, in a state where strain is applied to the steel sheet by the polishing, it is difficult to measure the crystal orientation. Therefore, the polished sample is formed not to have strain using a polishing material such as colloidal silica in a final step of polishing. Using the polished sample, a cross-section is observed with an FE-SEM, and subsequently the crystal orientation is measured by EBSD measurement. Regarding the FE-SEM, “SU_70” (manufactured by Hitachi High-Tech Corporation) is used as an example. Regarding the EBSD measurement, “Digiview” manufactured by TSL Solutions Co., Ltd. is used as an example. As a specific method, the following examples can be used. Using the FE-SEM, a range of the cross section including the base steel sheet, the oxide layer, and the insulating coating layer is observed at a magnification of 500-fold to obtain an electron microscopic image. An interface between the insulating coating layer described below and the oxide layer and an interface between the oxide layer and the steel sheet are identified based on a difference in electron density in the electron microscopic image. During the identification of the above-described interfaces, when an elemental analyzer (EDS) is attached to the FE-SEM, the interfaces can be more accurately identified based on a difference between the elemental species, such as P, B, O, or Fe, in the insulating coating layer, the oxide layer, and the silicon steel sheet.

Next, in the cross section in the same field of view, the crystal orientation of the steel sheet is measured by EBSD. Specifically, in the field of view at 500-fold where it is assumed that flat grains of 100 or more are included, a region with a cross section having a length of 200 μm in the rolling direction and a length of 70 μm in the sheet thickness direction is set as a target, and the crystal orientation is measured at a measurement point pitch of 0.25 μm. A boundary having a crystal orientation difference of 15° or more is identified as a grain boundary, and a range surrounded by this grain boundary is identified as a grain. When the number of grains is less than 100 in the field of view, the measurement is performed in an additional field of view.

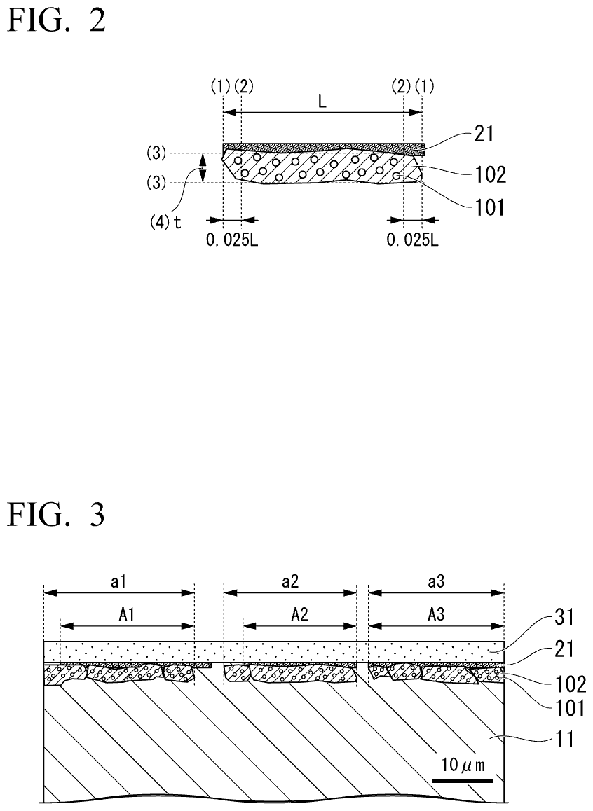

Regarding the grains, the average thickness of the grains is obtained using a method illustrated in a) to d) as illustrated in FIG. 2.

a) Imaginary lines (1) for determining both ends of a grain are drawn in the sheet thickness direction (normal direction) of the steel sheet.

b) With respect to a distance L between both ends, imaginary lines (2) (lines between which a portion represents a 95% width of the grain) in the sheet thickness direction are drawn at a point of 2.5% of L from each of both ends of the grain.

c) Regarding the portion (the 95% width portion of the grain) between the imaginary lines drawn in b), average lines (3) are drawn at an interface between the grain and the oxide layer and an envelope of the lower side (grain boundary opposite to the oxide layer) of the grain.

d) The distance between the two average lines drawn in c) is obtained as a thickness t(4) (the average value of the five points in total including both ends, the center, and intermediate points between both ends and the center).

In addition, the range of both ends of the grain drawn in a) is obtained as the width of the grain to calculate the aspect ratio.

Among the grains, regarding all of grains where the average thickness is 0.5 to 5.0 μm and the aspect ratio is 1.5 or more, the crystal orientation of ferrite of Fe is measured. On a crystal orientation map called an IPF map where the measured crystal orientations are plotted, crystal orientations with respect to the rolling direction (RD direction) and the sheet surface normal direction (ND direction) are plotted. The average of orientation differences of the grains from Goss orientation is calculated to obtain the deviation from Goss orientation. When the deviation from Goss orientation is 10° or more, this grain is identified as a flat grain.

The average (simple average) of the average thicknesses of the flat grains can be obtained by the sum of the average thicknesses of the flat grains obtained as described above by the number of the flat grains.

Since the flat grain is flat in the rolling direction (longitudinal direction) and the width direction, a cross section in the sheet thickness direction may be observed using any method. A method of obtaining a surface of the above-described steel sheet parallel to the rolling direction (RD direction) as a cross section, obtaining the crystal orientation map by EBSD, and verifying the presence of “flat grain” is preferable due to the high accuracy. As another method for simply verifying the presence of “flat grain”, a method of polishing a surface parallel to the rolling direction (RD direction) to obtain a smooth cross section and subsequently causing a grain boundary to appear using such as a so-called Nital method (nitric acid ethanol method, described in JIS-G-0553 (2019) or the like) can be used. However, in this method, the crystal orientation cannot be identified and needs to be measured separately by EBSD or the like. Therefore, in the present embodiment, a method of combining FE-SEM and EBSD described above is most suitable.

In addition, a proportion of a length of grain boundaries of the flat grains in a length of the interface between the base steel sheet and the oxide layer can be obtained using the following method.

For example, in a field of view observed at a magnification of 500-fold, regarding the interface between the silicon steel sheet and the oxide layer, a region with a cross section having a length of 200 μm in the rolling direction is set as a target, and the SEM observation and the EBSD measurement are performed. Regarding five points, that is, the portion corresponding to an interface length of 1000 μm, the SEM observation and the EBSD measurement are performed. The proportion (percentage) of the length of the grain boundaries of flat grains where the average thickness is 0.5 to 5.0 μm, the aspect ratio is 1.5 or more, and the orientation difference from Goss orientation is 10° or more in the length (1000 μm) of the interface between the silicon steel sheet and the oxide layer is measured.

The identification and the like of insulating coating layer, the oxide layer, the interface of the silicon steel sheet, and the flat grains can be performed in the same manner as described above.

During the measurement, in a measurement range B, a length of a portion where the oxide layer is formed on the surface of the silicon steel sheet is set as B′ (when the oxide layer is formed on the entire area of the measurement range, B=B′). In this case, lengths of portions where flat grains are formed on the outermost layer of the silicon steel sheet and an interface between the silicon steel sheet and the oxide layer is a grain boundary between the flat grains are set as b1, b2, . . . , bi (in the drawing, i=3), and the sum (Σbi) of the lengths b1 to bi is divided by B′ (Σbi/B′) that is the length of the portion where the oxide layer is formed on the surface of the silicon steel sheet to measure the proportion of the length of the grain boundaries of the flat grains in the length of the interface between the base steel sheet and the oxide layer.

### (Thermal Strain)

By periodically forming, in the rolling direction, a linear thermal strain extending in a direction intersecting the rolling direction, a magnetic domain control can be performed. In the grain-oriented electrical steel sheet according to the present embodiment, the thermal strain is imparted to the steel sheet after an insulating coating forming step during the manufacture of the grain-oriented electrical steel sheet.

Specifically, after applying a coating solution containing an insulating coating component having a tension imparting function to the steel sheet after finish annealing, annealing that also functions as the baking of the coating and the flattening of the steel sheet is performed. After the annealing for the baking and the flattening, the thermal strain is imparted to the steel sheet.

The thermal strain is a linear thermal strain extending in a direction of 80 to 100° with respect to the rolling direction of the grain-oriented electrical steel sheet. A plurality of the thermal strains are periodically present in the rolling direction, and an interval in the rolling direction between thermal strain-imparted regions adjacent to each other is 1.0 to 20.0 mm. It is preferable that the thermal strains are substantially parallel to each other and the intervals in the rolling direction are regular intervals. The interval between the thermal strain-imparted regions is the distance from the center of one thermal strain-imparted regions to the center of another thermal strain-imparted regions adjacent thereto. The thermal strain can be imparted by irradiation with a laser, an electron beam, or a plasma as described below.

The anomalous eddy current loss reduction effect by the above-described flat grains is exhibited even when the magnetic domain control is performed by forming the thermal strain-imparted regions. Further, the following thermal strain-imparted magnetic domain control has a secondary effect.

That is, in the entire region in the surface of the steel sheet, the uniform formation of the oxide layer in a region of a predetermined thickness from the surface can further uniformize the color tone distribution of the surface. In addition, the formation of the oxide on the surface layer of the steel sheet and on the surface in the predetermined thickness direction increases and uniformizes the emissivity in the entire region in the surface of the steel sheet. That is, when the thermal strain is imparted, the energy is likely to be uniformized and absorbed by irradiation with a laser or an electron beam, and thus the iron loss reduction and a reduction in variation can be achieved. As a result, the magnetic domain width at each of points of the steel sheet can be reduced, and thus the iron loss reduction can be achieved.

In other words, in the steel sheet where the flat grains are controlled, by performing the magnetic domain control by the thermal strain imparting, due to the synergistic effect, the higher effects can be obtained as compared to when each of the controls is performed alone.

The chemical composition of the base steel sheet (silicon steel sheet) is not limited and may be the same as that of a base steel sheet of a well-known grain-oriented electrical steel sheet. For example, the chemical composition may be in the following ranges.

The chemical composition of the base steel sheet contains Si: 2.00 to 6.00% by mass % and the remainder consisting of Fe and impurities. The reason for this chemical composition is to control the Goss texture where the crystal orientation is integrated in the {110}<001> orientation and to ensure favorable magnetic characteristics. The other elements are not particularly limited, and the chemical composition is allowed to contain a well-known element in a well-known range instead of Fe. Representative content ranges (mass %) of representative elements other than Si are as follows.
C: 0 to 0.0050%,
Mn: 0 to 1.0%,
S: 0 to 0.0150%,
Se: 0 to 0.0150%,
Al: 0 to 0.0650%,
N: 0 to 0.0050%,
Cu: 0 to 0.40%,
Bi: 0 to 0.010%,
B: 0 to 0.080%,
P: 0 to 0.50%,
Ti: 0 to 0.0150%,
Sn: 0 to 0.10%,
Sb: 0 to 0.10%,
Cr: 0 to 0.30%,
Ni: 0 to 1.0%,
Nb: 0 to 0.030%,
V: 0 to 0.030%,
Mo: 0 to 0.030%,
Ta: 0 to 0.030%, and
W: 0 to 0.030%.

Since these optional elements may be contained depending on the object, it is not necessary to limit the lower limit, and these optional elements may not be substantially contained. In addition, even if these optional elements are contained as the impurity, the effects of the present invention are not impaired. Here, the impurity refers to an element that is unintentionally contained, and means an element that is mixed from ore as a raw material, scrap, a manufacturing environment, or the like when the base steel sheet is industrially manufactured.

Regarding the chemical composition of the silicon steel sheet, the base steel sheet is decomposed by an acid such as hydrochloric acid to obtain a solution. Each of element solutions having a known concentration is analyzed by ICP (inductively coupled plasma) analysis to obtain a calibration curve. By analyzing the obtained solution, the content of the element can be determined and obtained.

In the grain-oriented electrical steel sheet where the oxide layer and the insulating coating layer are formed on the surface of the base steel sheet (silicon steel sheet), the measurement is performed after removing the oxide layer and the insulating coating layer.

The insulating coating layer can be removed by immersing the grain-oriented electrical steel sheet in a sodium hydroxide aqueous solution containing 30 to 50 mass % of NaOH and 50 to 70 mass % of H₂O at 80 to 90° C. for 7 to 10 minutes.

In addition, the grain-oriented electrical steel sheet from which the insulating coating layer has been removed is cleaned with water, and after water cleaning, dried with a warm air blower for slightly less than 1 minute. The oxide layer is removed by immersing the grain-oriented electrical steel sheet after drying (the grain-oriented electrical steel sheet not including the insulating coating layer) in a hydrochloric acid aqueous solution containing 10 mass % of HCl at 80 to 90° C. for 1 to 10 minutes.

The immersed base steel sheet is cleaned with water, and after water cleaning, dried with a warm air blower for slightly less than 1 minute. As a result, the base steel sheet (silicon steel sheet) can be extracted from the grain-oriented electrical steel sheet including the oxide layer and the insulating coating layer.

### (Sheet Thickness)

The sheet thickness of the silicon steel sheet (base steel sheet) of the grain-oriented electrical steel sheet according to the present embodiment is not limited and is preferably 0.15 to 0.35 mm in consideration of the iron loss value. When the sheet thickness is more than 0.35 mm, the above-described classical eddy current loss increases due to the large sheet thickness, and iron loss increases. On the other hand, when the sheet thickness is less than 0.15 mm, the rolling efficiency decreases, which is disadvantageous in productivity and costs.

### [Oxide Layer]

In the grain-oriented electrical steel sheet according to the present embodiment, the oxide layer formed of the oxide of one or more kinds of Mg, Al, and Si is formed on the surface of the silicon steel sheet (base steel sheet).

The oxide layer is formed by a solid phase reaction of Mg and/or Al in the annealing separator and the Si-based pre-oxide formed on the sheet surface during finish annealing. For example, when the annealing separator containing MgO is used, a forsterite (Mg₂SiO₄) coating layer is mainly formed as the oxide layer. In addition, AlN contained as the inhibitor in the steel is oxidized by oxygen in the annealing atmosphere on the surface of the silicon steel sheet in the latter half of finish annealing. Accordingly, spinel (MgAl₂O₄), alumina (Al₂O₃), or mullite (2SiO₂·3Al₂O₃) is formed. When the annealing separator formed of only MgO is used, the oxide is formed as substantially spinel (MgAl₂O₄).

By covering the surfaces of the flat grains with the oxide layer, an effect of improving the adhesion with the insulating coating layer formed as an upper layer of the oxide layer can be obtained. When the sufficient effect is obtained, the coverage of the oxide layer on the flat grains is preferably 50% or more.

The coverage can be obtained using the following method. That is, the presence of the flat grains is identified by EBSD in the above-described manner. In addition, an FE-SEM image of each of the flat grains or an element analysis image obtained by performing elemental analysis on the FE-SEM image by EDS or the like is focused on. In a projection portion of the flat grains between the insulating coating layer and the flat grains or in a direction from the surface side of the flat grains to the inside of the steel sheet, a length of a portion where the oxide layer of one or more kinds of Mg, Al, and Si is present is measured. In the portion corresponding to an interface length of 1000 μm between the oxide layer or the insulating coating layer and the flat grains, the ratio of the length of the portion where the oxide layer is present is obtained as a percentage.

For example, in the state illustrated in FIG. 3, the coverage (%) can be obtained from (A1+A2+A3)/(a1+a2+a3)×100.

### [Insulating Coating Layer]

In the grain-oriented electrical steel sheet according to the present embodiment, the insulating coating layer is formed (as the upper layer) on the surface of the oxide layer. This insulating coating layer is essential when the grain-oriented electrical steel sheet is used as a transformer. For use as a transformer, the grain-oriented electrical steel sheets are laminated and used. When a short-circuit occurs between the laminated steel sheets (silicon steel sheets), an eddy current is generated in a transformer core, which causes an increase in core iron loss. Therefore, by forming the insulating coating layer on the sheet surface to impart electrical insulation properties, the core iron loss of the transformer is reduced. In addition, by applying tension to the steel sheet in the insulating coating of the grain-oriented electrical steel sheet, the magnetic domain width can be reduced, and a reduction in anomalous eddy current loss and a reduction in iron loss can be achieved.

In addition, the insulating coating of the grain-oriented electrical steel sheet is required to have not only the above-described electrical insulation properties but also various properties such as corrosion resistance, heat resistance, and slippage necessary for forming a core. In consideration of these needs, as the insulating coating, for example, a coating species containing a phosphate and colloidal silica as a major component is used. In addition, in order to apply a higher tension to the steel sheet, a coating containing aluminum borate as a major component or a coating formed of aluminum borate and silica may also be used. Any of the coatings may be a well-known coating that is formed by applying a coating solution where the components in the coating are dissolved or dispersed to the surface of the oxide layer and baking the coating film.

### <Manufacturing Method>

The effect of the grain-oriented electrical steel sheet according to the present embodiment can be obtained regardless of the manufacturing method as long as the grain-oriented electrical steel sheet has the above-described characteristics, but a manufacturing method including the following step is preferable because such a manufacturing method enables stable manufacture.

The manufacturing method includes:
(I) a hot rolling step of heating and hot rolling a slab to obtain a hot rolled sheet;
(II) a hot rolled sheet annealing step of annealing the hot rolled sheet after the hot rolling step;
(III) a pickling step of pickling the hot rolled sheet after the hot rolled sheet annealing step;
(IV) a cold rolling step of cold rolling the hot rolled sheet after the pickling step to obtain a cold rolled sheet;
(V) a grinding step of grinding a surface of the cold rolled sheet after the cold rolling step;
(VI) a contact step of bringing the cold rolled sheet after the grinding step into contact with an aqueous solution of pH 4.0 to 10.0;
(VII) a decarburization annealing step of performing decarburization annealing on the cold rolled sheet after the contact step;
(VIII) a finish annealing step of applying an annealing separator to the cold rolled sheet after the decarburization annealing step and subsequently performing finish annealing to form an oxide layer formed of one or more kinds of Mg, Al, and Si on a surface of the cold rolled sheet that is a silicon steel sheet (base steel sheet);
(IX) an insulating coating forming step of forming an insulating coating layer on a surface of the oxide layer after the finish annealing step to obtain a grain-oriented electrical steel sheet including the silicon steel sheet, the oxide layer, and the insulating coating layer; and
(X) a magnetic domain control step of irradiating a surface of the grain-oriented electrical steel sheet after the insulating coating forming step with a laser, an electron beam, or a plasma to form a plurality of linear thermal strains extending in a direction having an angle of 80 to 100° with respect to a rolling direction on the surface of the silicon steel sheet such that each of intervals in the rolling direction is 1.0 to 20.0 mm.

In addition, the manufacturing method for a grain-oriented electrical steel sheet according to the present embodiment may further include one or more of the following steps.

(XI) a nitriding treatment step of increasing the nitrogen content in the cold rolled sheet.

The manufacturing method for a grain-oriented electrical steel sheet according to the present embodiment is characterized in the grinding step, the contact step, and the magnetic domain control step among the above-described steps. On the other hand, the hot rolling step, the hot rolled sheet annealing step, the cold rolling step, the decarburization annealing step, the nitriding treatment step, the finish annealing step, and the insulating coating forming step can be performed under well-known conditions.

Hereinafter, preferable conditions will be described. Known conditions can be applied to conditions that are not described.

### [Hot Rolling Step]

In the hot rolling step, a slab having a predetermined chemical composition (the chemical composition corresponding to the chemical composition of the silicon steel sheet of the grain-oriented electrical steel sheet according to the present embodiment) is heated and hot-rolled to obtain a hot rolled sheet.

The conditions are not limited, but the slab heating temperature is, for example, 1000 to 1400° C.

The chemical composition of the slab subjected to hot rolling may be determined depending on the desired chemical composition to be obtained as the grain-oriented electrical steel sheet in consideration of a change in chemical composition in each of the steps.

When the preferable chemical composition of the silicon steel sheet of the grain-oriented electrical steel sheet according to the present embodiment is obtained, for example, it is preferable to use a slab having the following chemical composition.

The chemical composition contains C: 0.040 to 0.100% and Si: 2.00 to 4.00% by mass %, contains Al, Mn, Se, S, B, N, and the like in the predetermined ranges such that AlN, MnS, MnSe, and BN are formed as the inhibitors, and optionally contains elements such as Cu, Sn, Cr, Ni, Mo, Nb, Bi, and Sb.

A method for obtaining the slab is not limited. For example, molten steel having a predetermined chemical composition may be prepared to manufacture the steel using this molten steel. For example, the slab may be manufactured by a continuous casting method. Alternatively, optionally, an ingot is manufactured using molten steel, and then the ingot is subjected to blooming and rolling to manufacture the slab. The slab may be manufactured by other methods.

The thickness of the slab is not particularly limited and is, for example, 150 to 350 mm. The thickness of the slab is preferably 220 to 280 mm. As the slab, a so-called thin slab with a thickness of 10 to 70 mm may be used.

A so-called hot rolled sheet (hot-rolled steel sheet) can be obtained by hot rolling. The sheet thickness (finished sheet thickness) of the hot rolled sheet is not particularly limited. Note that the hot rolled sheet is subjected to hot rolled sheet annealing and cold rolling after pickling. It is known that a so-called cold rolling ratio affects the magnetic characteristics of the grain-oriented electrical steel sheet, and the sheet thickness of the hot rolled sheet is selected also in consideration of a cold rolling ratio necessary for the final sheet thickness. For example, when the final sheet thickness is 0.20 to 0.30 mm, the finished sheet thickness of the hot rolled sheet is preferably in a range of 2.0 to 4.0 mm.

### [Hot Rolled Sheet Annealing Step]

In the hot rolled sheet annealing step, the above-described hot rolled sheet after the hot rolling step is annealed. By performing such an annealing treatment, recrystallization occurs in the microstructure, and favorable magnetic characteristics can be realized.

In the hot rolled sheet annealing step of the present embodiment, the hot rolled sheet manufactured through the hot rolling step may be annealed according to a known method. A means of heating the hot rolled sheet at the time of annealing is not particularly limited, and a known heating method can be adopted. For example, so-called continuous annealing may be performed, or the hot rolled sheet may be formed in a coil shape to perform batch annealing. The annealing conditions are also not particularly limited, but for example, the hot rolled sheet can be annealed in a temperature range of 900 to 1200° C. for 10 seconds to 5 minutes. In addition, the atmosphere is not particularly limited. However, it is preferable that the oxidation of the steel sheet is suppressed, and it is preferable that the annealing is performed in a non-oxidizing atmosphere such as nitrogen, argon, or hydrogen.

### [Pickling Step]

In the pickling step, the hot rolled sheet after the hot rolled sheet annealing step is pickled, and scale (oxide) produced on the surface in hot rolling and hot rolled sheet annealing is removed. In the pickling step according to the present embodiment, a well-known method is used. As a pickling solution, a well-known acid such as hydrochloric acid, sulfuric acid, or nitric acid is used. In addition, optionally, a well-known pickling inhibitor, a pickling accelerator, or the like may be added to the pickling solution. Further, the pickling solution may be caused to permeate into an interface between the scale and the steel sheet before bringing the steel sheet into contact with the pickling solution such that a physical treatment such as shot blasting can also be performed on the steel sheet before pickling in order to improve the pickling efficiency.

### [Cold Rolling Step]

In the cold rolling step, the hot rolled sheet after the hot rolled sheet annealing step is pickled and cold-rolled to obtain a cold rolled sheet. The cold rolling may be one time of cold rolling (a series of cold rolling without intermediate annealing). Before a final pass of the cold rolling step, cold rolling may be interrupted, at least one or more times of intermediate annealing may be performed, and a plurality of times of cold rolling may be performed with intermediate annealing interposed therebetween.

Conditions of the cold rolling may be determined with reference to a well-known method. The cold rolling ratio in the grain-oriented electrical steel sheet largely affects magnetic characteristics thereof. In particular, the effect of the final rolling reduction is large, and the final rolling reduction can be set to be in a range of 80 to 95%. The final rolling reduction is a cumulative rolling reduction of cold rolling, and when intermediate annealing is performed, the final rolling reduction is a cumulative rolling reduction of cold rolling after the final intermediate annealing.

When the intermediate annealing is performed, it is preferable to hold the intermediate annealing at a temperature of, for example, 800 to 1200° C. for 5 to 180 seconds. The annealing atmosphere is not particularly limited, and it is preferable that the annealing is performed in a non-oxidizing atmosphere such as nitrogen, argon, or hydrogen in order to prevent the oxidation of the steel sheet. In addition, as the annealing method, any of continuous annealing or batch annealing in a coil shape may be used, or another method may be used. The number of times of intermediate annealing is preferably three or less in consideration of manufacturing cost.

### [Grinding Step]

In the grinding step, the surface of the cold rolled sheet after the cold rolling step is ground. At this time, using abrasive grains having a Knoop hardness of 1000 or more or using abrasive paper, a roll, or a brush to which the abrasive grains are fixed, the surface of the cold rolled sheet is ground. When the coil-shaped cold rolled sheet is ground, it is preferable that the grinding is continuously performed using a pass line from the viewpoints of productivity and quality. In this case, a brush into which the abrasive grains are fixed is generally used. Of course, a sheet-shaped cold rolled sheet can be used instead of the coil. In this case, the grinding can also be performed using abrasive paper or the like.

As described above, by allowing the inhibitors (precipitates such as AlN present in the grain boundary) to be present at as a high temperature as possible during finish annealing, only grains having a crystal orientation closer to ideal Goss orientation are allowed to grow, and the magnetic flux density is improved.

However, the sizes of the inhibitors are extremely small at several tens to several hundreds of nm and have a distribution. When the sizes have a distribution, the inhibitor having a small size starts to be decomposed at a low temperature. In this case, secondary recrystallization of only grains having a crystal orientation closer to Goss orientation (ideal Goss orientation) is difficult, and it is difficult to improve the magnetic flux density. On the other hand, it is industrially very difficult to control the sizes of the inhibitors to be fixed to a preferable size (such that a difference between the sizes is reduced).

On the other hand, as long as the inhibitors can be allowed to be present at a high temperature by suppressing the decomposition and oxidation of the inhibitors, secondary recrystallization of only grains having a crystal orientation closer to ideal Goss orientation can be caused to occur. In addition, it is known that the above-described Si-based pre-oxide formed on the base steel sheet (the cold rolled sheet for forming the base steel sheet) in the decarburization annealing step contributes to the suppression of the decomposition and oxidation of the inhibitors.

However, the Si-based pre-oxide is likely to affect the previous step of the decarburization annealing step, and the formation state in each of parts of the surface of the sheet surface is likely to be non-uniform. When the formation state is non-uniform, the effect of suppressing the decomposition and oxidation of the inhibitors varies depending on locations in the steel sheet surface, and the desired effect cannot be obtained.

Therefore, in the manufacturing method for a grain-oriented electrical steel sheet according to the present embodiment, the formation state of the oxide layer after finish annealing is as uniform as possible in a region of a predetermined thickness from the surface of the steel sheet. Therefore, an Fe-based oxide or a reactant of an oil-based agent, an extreme pressure additive, or the like and the sheet surface, which are non-uniformly formed on the sheet surface by performing cold rolling or the like, is removed from the sheet surface before decarburization annealing by grinding the sheet surface.

Specifically, using abrasive grains having a Knoop hardness of 1000 or more or using abrasive paper, a roll, or a brush to which the abrasive grains are fixed, at least one surface of the steel sheet is ground to remove the Fe-based oxide film or the reactant from the sheet surface. When the Knoop hardness is less than 1000, the hardness of the abrasive grains is insufficient for the steel sheet, and thus it is difficult to perform the grinding. In addition, the grinding efficiency decreases. In addition, when the maximum grain size of the abrasive grains is less than 30 μm, the grain size of the abrasive grains is small relative to the roughness of the sheet surface, and thus it is difficult to perform the grinding, or the grinding efficiency decreases, which is not preferable. On the other hand, when the maximum grain size is more than 300 μm, the grain size of the abrasive grains is excessively large relative to the roughness of the sheet surface. Therefore, surface scratches are likely to be conspicuous during grinding, and the quality of the external appearance of the product decreases, which is not preferable. The upper limit of the Knoop hardness is not limited. However, hard abrasive grains are likely to be brittle, and a problem such as grinding failure is likely to occur when abrasive paper, a roll, or a brush including the abrasive grains is continuously used. Therefore, the upper limit of the Knoop hardness is preferably 8000 or less and more preferably 5000 or less. As the abrasive grains, alumina (Knoop hardness: about 2000), silicon carbide (Knoop hardness: about 2500), boron nitride (Knoop hardness: about 5000), diamond (Knoop hardness: about 7000), or the like is mainly used.

Specifically, the step of grinding the cold rolled sheet will be described by using an example where a brush roll containing the abrasive grains is used. In the brush roll, resin lining is performed on a surface of a metal roll to embed the above-described abrasive grains in fibers formed of an acrylic resin or the like, and the abrasive grains are embedded in a capillary shape in the resin layer surface of the roll surface. An example of application to a continuous pass line will be described. When the steel sheet is ground using the brush roll, the passing speed of the steel sheet is in a range of about 20 to 200 mpm (meter per minute), and at a position where the steel sheet and the brush roll are brought into contact with each other while moving the steel sheet, the brush roll that rotates in a direction facing a steel sheet passing direction is brought into contact with the steel sheet to grind the steel sheet. When the steel sheet is ground using the brush roll, the steel sheet is interposed between the brush roll and an idle roll, and the brush roll is rolled and pressed against the idle roll side for grinding the steel sheet in the pass line. At this time, the rolling reduction is preferably about 1.0 to 5.0 mm. Typically, a brush roll having a diameter of about 200 to 500 mm is used. The reason for this is as follows. When the diameter of the brush roll is excessively small, the abrasion of the brush or the abrasive grains is accelerated. When the diameter of the brush roll is excessively large, the metal roll excessively becomes large, and a large-scale facility is required. The brush grinds the steel sheet while rotating in the direction facing the passing direction of the steel sheet as described above. The passing speed of the steel sheet is in a range of 20 to 200 mpm as described above. In this case, the rotation speed of the brush is preferably about 500 to 2000 mpm from the viewpoint of adjusting the amount of abrasion to be in the predetermined range. When the rotation speed is low, the amount of abrasion is small. When the rolling reduction increases to increase the amount of abrasion, the brush roll and the passing of the steel sheet face each other. Therefore, so-called “chattering” is likely to occur, in which the steel sheet cannot pass smoothly due to a frictional force between the steel sheet and the brush roll such that inching occurs. “Chattering” is not preferable because it causes the grinding of the sheet surface to be non-uniform, and thus this phenomenon should be avoided. In addition, when the rotation speed of the brush roll is larger than 2000 mpm, the frictional force between the brush roll and the passing of the steel sheet excessively increases. Therefore, the above-described “chattering” occurs, and also an overload is generated from a motor that drives the brush roll, which is not preferable.

In addition, in order to sufficiently remove the Fe-based oxide film or the reactant that are non-uniformly formed on the surface of the cold rolled sheet, the amount of abrasion on at least one surface is 0.10 g/m² or more. The Fe-based oxide film or the reactant is sufficiently removed from the sheet surface, but the lifetime of the abrasive grains decreases or the occurrence of sludge becomes significant along with grinding. For this treatment, time and labor is required, which causes defects of the sheet surface due to pressing or the like. Therefore, the amount of abrasion is 3.00 g/m² or less.

The amount of abrasion can be verified from a difference in the weight of the steel sheet before and after grinding. The amount of abrasion is the amount of abrasion of one surface, and when grinding is performed on both surfaces, the amount of abrasion of both surfaces is obtained, and the numerical value thereof is halved for convenience of description. From the viewpoint of removing the Fe-based oxide film or the reactant from all of the surfaces of the steel sheet, the amount of abrasion is preferably in a range of 0.30 g/m² or more and 3.00 g/m² or less.

### [Contact Step]

In the contact step, the surface of the cold rolled sheet is brought into contact with an aqueous solution of pH 4.0 to 10.0 after the grinding step and before the decarburization annealing step. As a result, the abrasive grains attached to the sheet surface during grinding or steel sludge produced are removed. The aqueous solution may be ion exchange water. In addition, the aqueous solution may contain a mineral such as Ca or Mg or may contain carbonic acid or silicic acid as a counter ion. In addition, about 0.01 wt % of an acid selected from sulfuric acid, nitric acid, phosphoric acid, carbonic acid, carboxylic acid, phosphonic acid, and the like may be added, and the pH may be adjusted with alkali metal, alkali earth metal, or the like to use the aqueous solution. In particular, carboxylic acid or phosphonic acid is highly effective for removing the abrasive grains or the sludge from the steel sheet. In the case of ion exchange water, from the viewpoint of preventing erosion, the electrical conductivity is preferably 0.1 to 10 μS/cm.

When the pH is less than 4.0, erosion of the steel sheet occurs due to etching of the sheet surface by an acidic aqueous solution. When the pH is more than 10.0, the oxidation of the ground metal surface is accelerated due to the action of an alkaline aqueous solution. Therefore, the effect decreases although the Fe-based oxide that is non-uniformly formed on the sheet surface is removed in the grinding step. In this case, the initial desired effect that is the uniform formation of the oxide layer and the oxide grains after finish annealing cannot be sufficiently obtained.

In order to achieve the above-described object, the contact time is preferably 0.1 to 60 seconds and more preferably 1 to 60 seconds. The contact time is still more preferably 5 to 60 seconds. The flow rate of the aqueous solution is preferably 1 to 100 L/min.

In addition, by performing the contact step, the abrasive grains or the sludge can be removed from the sheet surface, and factors of inhibiting the uniform formation of the oxide layer and the oxide grains after finish annealing can be avoided.

When the contact step is performed, the contact step is performed after the grinding step in consideration of the above-described object.

Even in the grinding step, the surface of the cold rolled sheet may be brought into contact with the aqueous solution. However, unless the contact step is performed after the grinding step, the above-described effect cannot be obtained.

### [Decarburization Annealing Step]

In the decarburization annealing step, decarburization annealing is performed on the cold rolled sheet after the grinding step. In the decarburization annealing, C that adversely affects magnetic characteristics is removed (decarburized) from the steel sheet, and the cold rolled sheet is primarily recrystallized.

Decarburization annealing conditions are not limited. Annealing is performed in a nitrogen/hydrogen mixed atmosphere for decarburization where oxygen potential is increased by humidification. In addition, it is necessary to form a primary recrystallized structure accordingly. Therefore, a humidification temperature (dew point) is determined from the viewpoint of an annealing temperature necessary for recrystallization and the oxygen potential where decarburization can be performed. The annealing temperature is about 700 to 900° C., and soaking is performed for about 60 seconds because annealing is performed in a general continuous annealing step. As described above, annealing is performed in the humidified atmosphere where the oxygen potential is high for decarburization. Therefore, it is known that Si in the steel is formed as a layered oxide on the sheet surface and as oxide grains in the steel sheet (hereinafter, referred to as the Si-based pre-oxide as described above).

### [Nitriding Treatment Step]

In the nitriding treatment step, by increasing the nitrogen content in the steel sheet to increase the amount of a nitride, secondary recrystallization of grains having a crystal orientation closer to Goss orientation can be accelerated in the finish annealing step. In the nitriding treatment step, the nitrogen content in the steel sheet after the nitriding treatment is preferably 0.015 to 0.050 mass %. The nitriding treatment method is not limited, and a well-known method may be used.

The nitriding treatment step is not essential and may be skipped. It is preferable that the nitriding treatment is performed between the decarburization annealing step and the finish annealing step.

### [Finish Annealing Step]

In the finish annealing step, the annealing separator is applied to the cold rolled sheet after the decarburization annealing step (when the nitriding treatment is performed, after the nitriding treatment step), and finish annealing is performed to form an oxide layer formed of an oxide of one or more kinds of Mg, Al, and Si on the surface of the cold rolled sheet for forming the base steel sheet (silicon steel sheet).

In the finish annealing, since the annealing time is long, typically, the steel sheet is coiled in a coil shape and batch annealing is performed. Since the steel sheet temperature increases up to about 1200° C., the annealing separator is applied to the coil-shaped steel sheet such that bake hardening does not occur in the steel sheet. As the annealing separator, in general, MgO is mainly used. By performing finish annealing after applying the annealing separator, a solid phase reaction occurs between Mg in the annealing separator and the Si-based pre-oxide formed on the sheet surface in the decarburization annealing step, and thus an oxide layer formed of an oxide of one or more kinds of Mg and Si is formed on the surface of the cold rolled sheet. For example, when the annealing separator containing MgO is used, a forsterite (Mg₂SiO₄) coating layer is mainly formed as the oxide layer. In addition, AlN contained as the inhibitor in the steel is oxidized by oxygen in the annealing atmosphere on the sheet surface in the latter half of finish annealing. At this time, the oxide is formed as spinel (MgAl₂O₄), alumina (Al₂O₃), or mullite (2SiO₂·3Al₂O₃). When the annealing separator formed of only MgO is used, the oxide is formed as substantially spinel (MgAl₂O₄).

In addition, in the finish annealing step, by secondarily recrystallizing primary recrystallized grains obtained by heating the steel sheet in the decarburization annealing step, grains having a crystal orientation close to Goss orientation are obtained, and by holding the steel sheet at an annealing temperature close to 1200° C. for a predetermined time, precipitates in the steel, for example, a nitride (example: AlN) or a sulfide (example: MnS) of which the function as the inhibitor ends are removed (purified) not to adversely affect magnetic characteristics.

In the manufacturing method for a grain-oriented electrical steel sheet according to the present embodiment, in the cold rolled sheet subjected to finish annealing, the sizes of the inhibitors are controlled to be larger than usual and to be uniform. Therefore, secondary recrystallization of only grains close to Goss orientation (grains having an orientation close to Goss orientation occurs).

Finish annealing conditions are not limited. For example, the temperature is increased from room temperature in a range of 10 to 100° C./h and is increased in a temperature range of 900 to 1000° C. where secondary recrystallization in Goss orientation generally occurs at 5 to 20° C./h to accelerate preferential growth in Goss orientation (secondary recrystallization). Next, the inhibitors of which the function ends are purified at about 1200° C. (for example, 1150 to 1250° C.) as described above. Next, the steel sheet is allowed to cool in a non-oxidizing atmosphere such as hydrogen or nitrogen, and the coil is extracted from a furnace.

### [Insulating Coating Forming Step]

In the coil after the finish annealing step, the insulating coating layer is formed on a part of outer surface of the steel sheet in the insulating coating forming step, and laminated as the grain-oriented electrical steel sheet and used for manufacturing a transformer. When a short-circuiting occurs in the laminate during operation as a transformer, the iron loss increases, which may also lead to burning of the transformer. Therefore, the insulating coating forming step is an important step. The annealing separator of the coil after the finish annealing step is removed by water cleaning or pickling, and the insulating coating layer is formed on the surface of the oxide layer formed on the sheet surface.

For example, the insulating coating layer can be formed by applying a coating solution containing phosphoric acid or a phosphate, colloidal silica, and chromic anhydride or a chromate to the cold rolled sheet after finish annealing (base steel sheet+oxide layer) and baking and drying the coating film at 300 to 950° C. for 10 seconds or longer. In addition, the atmosphere during baking is not particularly limited. However, it is preferable that the oxidation of the steel sheet is suppressed, and it is preferable that the annealing is performed in a non-oxidizing atmosphere such as nitrogen, argon, or hydrogen. In addition, as the coating species, a coating solution containing boric acid and alumina sol as a major component instead of the above-described phosphate, or a coating solution containing boric acid and an aluminosilicate (for example, kaolin mineral) as a major component can be used to form an insulating coating containing aluminum borate as a major component. By applying aluminum borate, a higher tension can be applied to the steel sheet, and thus iron loss can be reduced. In addition, in this step, a function of flattening, by continuous annealing, the steel sheet that is coiled in a coil shape by batch annealing in the above-described finish annealing is also exhibited. That is, by performing continuous annealing while baking the insulating coating and applying a fixed tension to the steel sheet having a coil shape at about 800° C., a flat steel sheet is obtained. Therefore, this step is also called the flattening annealing step.

Through these steps, the grain-oriented electrical steel sheet including the base steel sheet (silicon steel sheet), the oxide layer, and the insulating coating layer can be obtained.

### [Magnetic Domain Control Step]

In the magnetic domain control step, the grain-oriented electrical steel sheet after the insulating coating forming step is irradiated with a laser, an electron beam, or a plasma to form a plurality of linear thermal strains extending in a direction having an angle of 80 to 100° with respect to a rolling direction on the surface of the base steel sheet such that each of intervals in the rolling direction is 1.0 to 20.0 mm.

By forming the above-described thermal strain-imparted regions on the surface of the grain-oriented electrical steel sheet, the magnetic domains are refined to reduce the iron loss. When the direction, the interval, and the like of the thermal strains are outside the above-described ranges, the sufficient effect cannot be obtained.

The thermal strains can be imparted by irradiation with a laser, an electron beam, a plasma, or the like under conditions where the base steel sheet does not melt. The conditions are not limited. For example, laser irradiation is performed using a continuous wave laser or a pulsed laser as the laser. For example, it is preferable that the average energy density described in Patent Document 1 is controlled to be in a range of 0.8 to 2.0 mJ/mm².

### EXAMPLES

### Example 1

Molten steel containing Si: 3.25 mass %, Mn: 0.13 mass %, S: 0.006 mass %, C: 0.050 mass %, acid-soluble Al: 0.025 mass %, and N: 0.007 mass % was continuously cast to obtain a slab having a thickness of 300 mm.

This slab was heated in an electric furnace adjusted in a nitrogen atmosphere at 1150° C. for 60 minutes, and rough hot rolling was performed to obtain a steel sheet having a sheet thickness of 40 mm. Further, finish rolling was performed to obtain a hot rolled sheet having a sheet thickness of 2.3 mm.

Next, hot rolled sheet annealing of performing cooling after heating at 1100° C. for 60 seconds in a continuous annealing furnace adjusted to a nitrogen atmosphere was performed.

The obtained steel sheet (hot rolled sheet) was pickled with 10% hydrochloric acid to remove scale of the steel sheet.

Next, cold rolling is performed to obtain a cold rolled sheet having a sheet thickness of 0.22 mm.

The surface of the obtained cold rolled sheet was ground using a brush containing various abrasive grains described in Table 1. After completion of the grinding, the surface was brought into contact with ion exchange water of pH=2.5 to 12.0. Note that, for comparison, some steel sheets were not ground, and some steel sheets were not brought into contact with ion exchange water after being ground. During the contact, the contact time was 5 seconds, and the flow rate of the aqueous solution was 10 L/min.

Regarding the steel sheet that was ground and was brought into contact with the aqueous solution (when both of the grinding and the contact with the aqueous solution were not performed, the cold rolled sheet after the cold rolling; or when the contact with the aqueous solution was not performed, the cold rolled sheet after the grinding step), a sample having a width of 1.0 m and a length of 1.0 m was collected to evaluate the external appearance of both surfaces thereof.

The determination criteria were as follows.
5: Very beautiful (no streak scratches in the passing direction)
4: Beautiful (about several number of streak scratches in the passing direction)
3: Partially containing streak scratches (the number of streak scratches in the passing direction: 20 or less)
1: Containing streak scratches on the entire surface or containing or unevenness due to attachment

In examples (evaluation: 1) where the external appearance was poor, the subsequent evaluation was not performed except for some examples.

In addition, regarding the steel sheet that was ground and was brought into contact with the aqueous solution (when both of the grinding and the contact with the aqueous solution were not performed, the cold rolled sheet after the cold rolling; or when the contact with the aqueous solution was not performed, the cold rolled sheet after the grinding step), decarburization annealing was performed under the following conditions. The annealing atmosphere was a nitrogen 50%+hydrogen 50% atmosphere, and the oxygen potential PH₂O/PH₂ was 0.30. Regarding the oxygen potential, the atmosphere was humidified to adjust the water content before being introduced into the furnace. In this atmosphere, decarburization annealing was performed by performing soaking at 850° C. for 60 seconds.

Next, soaking is performed in a nitrogen-hydrogen-ammonia atmosphere at 750° C. for 30 seconds to perform a nitriding treatment. At this time, the ammonia concentration was adjusted such that the nitrogen content in the steel sheet after the nitriding treatment was N: 0.020 mass %.

Next, a water slurry of an annealing separator containing MgO as a major component was adjusted, and the annealing separator was applied to both surfaces of the steel sheet such that the adhesion amount of one surface after drying was 6 g/m², and was dried. At this time, regarding the composition of the annealing separator, the components were added such that the amount of TiO₂ was 5 parts by weight with respect to MgO: 100 parts by mass, and the amount of FeCl₂ was 0.020 mass % in terms of Cl.

Next, as finish annealing, the steel sheet was put into a batch annealing furnace, was heated in a nitrogen 50%+hydrogen 50% atmosphere at an average heating rate of 20° C./h, and was heated up to 1200° C. Next, the atmosphere was replaced with hydrogen 100%, soaking was performed for 20 h, and the temperature was decreased.

After completion of the finish annealing, the steel sheet was extracted from the furnace, and the annealing separator was removed by water cleaning. At this time, on the surface of the steel sheet (silicon steel sheet), after completion of secondary recrystallization, a glass coating formed of forsterite and an oxide layer formed of granular spinel (MgAl₂O₄), alumina (Al₂O₃), and/or mullite formed between the glass coating and the steel sheet were formed.

A chemical containing an insulating coating component formed of aluminum phosphate, colloidal silica, and chromic anhydride was applied to the steel sheet (the steel sheet where the glass coating as the oxide layer was formed on the surface of the silicon steel sheet as the base steel sheet), and the steel sheet was heated to 800° C. in a nitrogen atmosphere and was held for 30 seconds to perform baking. At this time, the adhesion amount of the insulating coating layer of one surface was 4.8 g/m². As a result, a grain-oriented electrical steel sheet was obtained.

The surface of the obtained grain-oriented electrical steel sheet (including the silicon steel sheet, the glass coating (oxide layer), and the insulating coating layer) was irradiated with a laser. At this time, a fiber laser having a laser output of 200 W was used, the irradiated laser beam diameter was adjusted to φ0.2 mm, and the irradiation energy density was adjusted to 1.5 mJ/mm². In addition, the scanning direction was a direction of 88° with respect to the steel sheet rolling direction, and the irradiation pitch (the interval in the rolling direction between the thermal strains) was 4.0 mm.

In the silicon steel sheet of the obtained grain-oriented electrical steel sheet, the number density of the oxide of one or more kinds of Mg, Al, and Si having an equivalent circle diameter of 0.1 to 3.0 μm in a range of 5 μm in the sheet thickness direction from the interface with the oxide layer, the coverage of the oxide layer, and the evaluation of the flat grains were performed using the above-described methods.

In the present example, the oxide of one or more kinds of Mg, Al, and Si having an equivalent circle diameter of 0.1 to 3.0 μm in a range of 5 μm in the sheet thickness direction from the interface with the oxide layer was spinel (MgAl₂O₄), alumina (Al₂O₃), or mullite (2SiO₂·3Al₂O₃), that is, an oxide containing Mg, Al, and Si.

### <Measurement of Magnetic Characteristics>

In addition, ten samples having a size of 500 mm in the sheet width direction×500 mm in the rolling direction were collected from the obtained grain-oriented electrical steel sheet. Next, using a single-sheet magnetic characteristic measurement method defined in the Single sheet test method described in JIS-C-2556:2015, a magnetic flux density (hereinafter, B8) during excitation at a magnetizing force of 800 A/m and an iron loss (hereinafter, W17/50) during excitation at an excitation frequency of 50 Hz and a magnetic flux density of 1.7 T were measured.

When B8 was 1.90 T or more and W17/50 was 0.73 W/kg or less, it was determined that magnetic characteristics were excellent.

### <Adhesion>

In addition, a sample having a size of 300 mm in the rolling direction×300 mm in the width direction was collected, this sample was coiled around a round bar of SUS304 having a diameter of 20 mm (φ20 mm) and was uncoiled. Next, the insulating coating of a recessed portion of the inside for coiling was observed to evaluate adhesion of the insulating coating.

The determination criteria were as follows.
G (GOOD): No coating peeling
P (POOR): Partial coating peeling
B (BAD): Coating peeling on the entire surface

TABLE 1

| | Brush | | | | | | | | | | |
|---|---|---|---|---|---|---|---|---|---|---|---|
| | | Abrasive Grains | | | | Grinding Method | | | | | |
| | Brush Roll | | | Maximum | Transport | | Rotation | | Contact | | |
| | Diameter | | Knoop | Grain | Speed | Ground | Speed | Pressing | Aqueous Solution | | |
| No. | mm | Kind | Hardness | Size μm | mpm | Surface | mpm | mm | Solvent | Additive | pH |
| 1 | — | — | — | — | — | — | — | — | No | No | No |
| | | | | | | | | | Contact | Contact | Contact |
| 2 | 300 | Alumina | 2000 | 30 | 30 | Both | 1200 | 2 | No | No | No |
| | | | | | | Surfaces | | | Contact | Contact | Contact |
| 3 | 300 | Alumina | 2000 | 20 | 30 | Both | 1200 | 2 | Pure | — | 6.0 |
| | | | | | | Surfaces | | | Water | | |
| 4 | 300 | Alumina | 2000 | 30 | 30 | Both | 1200 | 2 | Pure | — | 6.0 |
| | | | | | | Surfaces | | | Water | | |
| 5 | 300 | Alumina | 2000 | 80 | 30 | Both | 1200 | 2 | Pure | — | 6.0 |
| | | | | | | Surfaces | | | Water | | |
| 6 | 300 | Alumina | 2000 | 125 | 30 | Both | 1200 | 2 | Pure | — | 6.0 |
| | | | | | | Surfaces | | | Water | | |
| 7 | 300 | Alumina | 2000 | 150 | 30 | Both | 1200 | 2 | Pure | — | 6.0 |
| | | | | | | Surfaces | | | Water | | |
| 8 | 300 | Alumina | 2000 | 300 | 30 | Both | 1200 | 2 | Pure | — | 6.0 |
| | | | | | | Surfaces | | | Water | | |
| 9 | 300 | Alumina | 2000 | 500 | 30 | Both | 1200 | 2 | Pure | — | 6.0 |
| | | | | | | Surfaces | | | Water | | |
| 10 | 300 | Alumina | 2000 | 1000 | 30 | Both | 1200 | 2 | Pure | — | 6.0 |
| | | | | | | Surfaces | | | Water | | |
| 11 | 300 | Silicon | 2500 | 60 | 30 | Both | 1200 | 2 | Pure | — | 6.0 |
| | | Carbide | | | | Surfaces | | | Water | | |
| 12 | 300 | Boron | 5000 | 60 | 30 | Both | 1200 | 2 | Pure | — | 6.0 |
| | | Nitride | | | | Surfaces | | | Water | | |
| 13 | 300 | Diamond | 7000 | 60 | 30 | Both | 1200 | 2 | Pure | — | 6.0 |
| | | | | | | Surfaces | | | Water | | |
| 14 | 300 | Alumina | 2000 | 30 | 30 | Both | 300 | 2 | Pure | — | 6.0 |
| | | | | | | Surfaces | | | Water | | |
| 15 | 300 | Alumina | 2000 | 30 | 30 | Both | 30 | 2 | Pure | — | 6.0 |
| | | | | | | Surfaces | | | Water | | |
| 16 | 300 | Alumina | 2000 | 80 | 30 | Both | 1200 | 2 | Pure | Oxalic | 2.5 |
| | | | | | | Surfaces | | | Water | Acid | |
| 17 | 300 | Alumina | 2000 | 80 | 30 | Both | 1200 | 2 | Pure | Sodium | 4.0 |
| | | | | | | Surfaces | | | Water | Oxalate | |
| 18 | 300 | Alumina | 2000 | 80 | 30 | Both | 1200 | 2 | Pure | Sodium | 5.0 |
| | | | | | | Surfaces | | | Water | Phosphate | |
| 19 | 300 | Alumina | 2000 | 80 | 30 | Both | 1200 | 2 | Pure | Calcium | 8.0 |
| | | | | | | Surfaces | | | Water | Carbonate | |
| 20 | 300 | Alumina | 2000 | 80 | 30 | Both | 1200 | 2 | Pure | Calcium | 10.0 |
| | | | | | | Surfaces | | | Water | Hydroxide | |
| 21 | 300 | Alumina | 2000 | 80 | 30 | Both | 1200 | 2 | Pure | Magnesium | 12.0 |
| | | | | | | Surfaces | | | Water | Hydroxide | |
| 22 | 300 | Alumina | 2000 | 30 | 30 | Both | 800 | 2 | Pure | — | 6.0 |
| | | | | | | Surfaces | | | Water | | |

TABLE 2

| | After | | Flat | | | | |
|---|---|---|---|---|---|---|---|
| | Grinding + Contact | | Grains | | | | |
| | Amount of | | | Average of | Oxide in Range of 5 μm from Interface | | Oxide |
| | Abrasion | Surface | Length | Average | between Base Steel Sheet and Oxide Layer | | Layer |
| | of One | External | Ratio | Thick- | | Density | Coverage |
| No. | Surface g/m² | Appearance | % | nesses μm | Kind | grains/(μm)² | % |
| 1 | — | — | 15 | 0.5 | Mg, Si, Al | 0.002 | 30 |
| 2 | 0.30 | 1 | 40 | 0.5 | Mg, Si, Al | 0.008 | 45 |
| 3 | 0.07 | 4 | 40 | 0.5 | Mg, Si, Al | 0.005 | 40 |
| 4 | 0.30 | 4 | 50 | 0.5 | Mg, Si, Al | 0.010 | 55 |
| 5 | 1.00 | 4 | 60 | 0.8 | Mg, Si, Al | 0.050 | 85 |
| 6 | 1.40 | 4 | 70 | 1.5 | Mg, Si, Al | 0.080 | 90 |
| 7 | 2.20 | 4 | 80 | 2.1 | Mg, Si, Al | 0.100 | 95 |
| 8 | 3.00 | 4 | 80 | 3.0 | Mg, Si, Al | 0.180 | 95 |
| 9 | 4.50 | 3 | 80 | 4.5 | Mg, Si, Al | 0.250 | 70 |
| 10 | 7.00 | 1 | Not Evaluated due to Poor External Appearance | | | | |
| 11 | 1.00 | 4 | 70 | 1.0 | Mg, Si, Al | 0.060 | 85 |
| 12 | 1.20 | 4 | 70 | 1.2 | Mg, Si, Al | 0.060 | 85 |
| 13 | 1.50 | 4 | 70 | 1.8 | Mg, Si, Al | 0.060 | 90 |
| 14 | 0.08 | 4 | 40 | 0.5 | Mg, Si, Al | 0.006 | 40 |
| 15 | 0.05 | 4 | 40 | 0.5 | Mg, Si, Al | 0.003 | 40 |
| 16 | 11.00 | 1 | Not Evaluated due to Poor External Appearance | | | | |
| 17 | 1.00 | 5 | 80 | 1.2 | Mg, Si, Al | 0.050 | 85 |
| 18 | 1.00 | 5 | 80 | 1.2 | Mg, Si, Al | 0.050 | 85 |
| 19 | 1.00 | 5 | 80 | 1.2 | Mg, Si, Al | 0.050 | 90 |
| 20 | 1.00 | 4 | 60 | 1.2 | Mg, Si, Al | 0.050 | 85 |
| 21 | 1.00 | 4 | 15 | 0.5 | Mg, Si, Al | 0.002 | 45 |
| 22 | 0.20 | 4 | 50 | 0.5 | Mg, Si, Al | 0.010 | 45 |

TABLE 3

| | Magnetic Characteristics | | | |
|---|---|---|---|---|
| | Magnetic Flux | Iron | | |
| | Density | Loss | Insulating | |
| | B8 | W17/50 | Coating | |
| No. | T | W/kg | Adhesion | Note |
| 1 | 1.88 | 0.78 | B | Comparative Example |
| 2 | 1.89 | 0.76 | P | Comparative Example |
| 3 | 1.89 | 0.76 | P | Comparative Example |
| 4 | 1.91 | 0.72 | G | Invention Example |
| 5 | 1.92 | 0.70 | G | Invention Example |
| 6 | 1.92 | 0.70 | G | Invention Example |
| 7 | 1.92 | 0.72 | G | Invention Example |
| 8 | 1.91 | 0.73 | G | Invention Example |
| 9 | 1.89 | 0.85 | P | Comparative Example |
| 10 | — | — | — | Comparative Example |
| 11 | 1.92 | 0.70 | G | Invention Example |
| 12 | 1.92 | 0.70 | G | Invention Example |
| 13 | 1.92 | 0.70 | G | Invention Example |
| 14 | 1.89 | 0.77 | P | Comparative Example |
| 15 | 1.89 | 0.77 | P | Comparative Example |
| 16 | — | — | — | Comparative Example |
| 17 | 1.92 | 0.70 | G | Invention Example |
| 18 | 1.92 | 0.70 | G | Invention Example |
| 19 | 1.92 | 0.70 | G | Invention Example |
| 20 | 1.92 | 0.70 | G | Invention Example |
| 21 | 1.88 | 0.86 | P | Comparative Example |
| 22 | 1.90 | 0.73 | G | Invention Example |

As can be seen from Tables 1 to 3, in the examples where the grinding of the surface of the steel sheet and the contact with the aqueous solution were performed under conditions of the present invention, the oxide of one or more kinds of Mg, Al, and Si having an equivalent circle diameter of 0.1 to 3.0 μm was present at a density of 0.010 to 0.200 grains/μm² in a range of 5 μm in the sheet thickness direction from the interface between the silicon steel sheet and the oxide layer, and in a cross section in the sheet thickness direction, a length of grain boundaries of the flat grains accounted for 50% or more of a length of the interface between the silicon steel sheet and the oxide layer. In addition, as a result, magnetic characteristics were excellent in these examples.

On the other hand, in the examples where the contact with the predetermined aqueous solution was not performed or the grinding conditions were not preferable, the external appearance that was usually required was not satisfied, the oxide of the surface layer area was not sufficiently formed, or the flat grains were not sufficiently formed. In addition, as a result, magnetic characteristics were poor (some of external appearance defects were not evaluated).

### Example 2

Using molten steel and slab of the same components as those used in Example 1, the hot rolling, the hot rolled sheet annealing, the pickling, and the cold rolling were performed using the same method as that of Example 1 to obtain a cold rolled sheet having a sheet thickness of 0.22 mm.

The surface of the obtained steel sheet was ground using a brush containing various abrasive grains described in Table 4, and was brought into contact with ion exchange water of pH 6.0. During the contact, the contact time was 5 seconds, and the flow rate of the aqueous solution was 10 L/min. Next, the decarburization annealing, the nitriding treatment, the application of the annealing separator, and the finish annealing were performed under the same method as that of Example 1, the annealing separator was removed by water cleaning, and the insulating coating layer was formed to obtain a grain-oriented electrical steel sheet.

The surface of the obtained grain-oriented electrical steel sheet (including the silicon steel sheet, the glass coating (oxide layer), and the insulating coating layer) was irradiated with a laser. At this time, a fiber laser having a laser output of 200 W as used, the irradiated laser beam diameter φ was adjusted to 0.2 mm, and the irradiation energy density was adjusted to 1.8 mJ/mm². In addition, the scanning direction was a direction of 75 to 105° with respect to the rolling direction of the steel sheet, and the irradiation pitch (the interval in the rolling direction between the thermal strains) was changed to a range of 0.5 to 25.0 mm.

In the silicon steel sheet of the obtained grain-oriented electrical steel sheet, the number density of the oxide of one or more kinds of Mg, Al, and Si having an equivalent circle diameter of 0.1 to 3.0 μm in a range of 5 μm in the sheet thickness direction from the interface with the oxide layer, the coverage of the oxide layer, and the evaluation of the flat grains were performed using the same methods as those of Example 1.

In the present example, the oxide of one or more kinds of Mg, Al, and Si having an equivalent circle diameter of 0.1 to 3.0 μm in a range of 5 μm in the sheet thickness direction from the interface with the oxide layer was spinel (MgAl₂O₄), alumina (Al₂O₃), or mullite (2SiO₂·3Al₂O₃), that is, an oxide containing Mg, Al, and Si.

### <Measurement of Magnetic Characteristics>

The evaluation was performed using the same method as that of Example 1.

### <Adhesion>

The measurement was performed using the same method as that of Example 1.

TABLE 4

| | Brush | | | | | | | | | | |
|---|---|---|---|---|---|---|---|---|---|---|---|
| | | Abrasive Grains | | | | Grinding Method | | | | | |
| | Brush Roll | | | Maximum | Transport | | Rotation | | Contact | | |
| | Diameter | | Knoop | Grain | Speed | Ground | Speed | Pressing | Aqueous Solution | | |
| No. | mm | Kind | Hardness | Size μm | mpm | Surface | mpm | mm | Solvent | Additive | pH |
| 101 | 300 | Alumina | 2000 | 80 | 30 | Both | 1200 | 2 | Pure | — | 6.0 |
| | | | | | | Surfaces | | | Water | | |
| 102 | 300 | Alumina | 2000 | 80 | 30 | Both | 1200 | 2 | Pure | — | 6.0 |
| | | | | | | Surfaces | | | Water | | |
| 103 | 300 | Alumina | 2000 | 80 | 30 | Both | 1200 | 2 | Pure | — | 6.0 |
| | | | | | | Surfaces | | | Water | | |
| 104 | 300 | Alumina | 2000 | 80 | 30 | Both | 1200 | 2 | Pure | — | 6.0 |
| | | | | | | Surfaces | | | Water | | |
| 105 | 300 | Alumina | 2000 | 80 | 30 | Both | 1200 | 2 | Pure | — | 6.0 |
| | | | | | | Surfaces | | | Water | | |
| 106 | 300 | Alumina | 2000 | 80 | 30 | Both | 1200 | 2 | Pure | — | 6.0 |
| | | | | | | Surfaces | | | Water | | |
| 107 | 300 | Alumina | 2000 | 80 | 30 | Both | 1200 | 2 | Pure | — | 6.0 |
| | | | | | | Surfaces | | | Water | | |
| 108 | 300 | Alumina | 2000 | 80 | 30 | Both | 1200 | 2 | Pure | — | 6.0 |
| | | | | | | Surfaces | | | Water | | |
| 109 | 300 | Alumina | 2000 | 80 | 30 | Both | 1200 | 2 | Pure | — | 6.0 |
| | | | | | | Surfaces | | | Water | | |
| 110 | 300 | Alumina | 2000 | 80 | 30 | Both | 1200 | 2 | Pure | — | 6.0 |
| | | | | | | Surfaces | | | Water | | |
| 111 | 300 | Alumina | 2000 | 80 | 30 | Both | 1200 | 2 | Pure | — | 6.0 |
| | | | | | | Surfaces | | | Water | | |
| 112 | 300 | Alumina | 2000 | 80 | 30 | Both | 1200 | 2 | Pure | — | 6.0 |
| | | | | | | Surfaces | | | Water | | |
| 113 | 300 | Alumina | 2000 | 80 | 30 | Both | 1200 | 2 | Pure | — | 6.0 |
| | | | | | | Surfaces | | | Water | | |

TABLE 5

| | | | | | | | | Laser | |
|---|---|---|---|---|---|---|---|---|---|
| | After | | Flat | | | | | Irradiation | |
| | Grinding + Contact | | Grains | | | | | Angle with | |
| | Amount of | | | Average of | Oxide in Range of 5 μm from Interface | | Oxide | respect to | |
| | Abrasion of | Surface | Length | Average | between Base Steel Sheet and Oxide Layer | | Layer | Rolling | |
| | One Surface | External | Ratio | Thick- | | Density | Coverage | Direction | Pitch |
| No. | g/m² | Appearance | % | nesses μm | Kind | grains/(μm)² | % | degrees | mm |
| 101 | 1.0 | 4 | 60 | 1.5 | Mg, Si, Al | 0.050 | 85 | 75 | 4.0 |
| 102 | 1.0 | 4 | 60 | 1.5 | Mg, Si, Al | 0.050 | 85 | 80 | 4.0 |
| 103 | 1.0 | 4 | 60 | 1.5 | Mg, Si, Al | 0.050 | 85 | 85 | 4.0 |
| 104 | 1.0 | 4 | 60 | 1.5 | Mg, Si, Al | 0.050 | 85 | 90 | 4.0 |
| 105 | 1.0 | 4 | 60 | 1.5 | Mg, Si, Al | 0.050 | 85 | 95 | 4.0 |
| 106 | 1.0 | 4 | 60 | 1.5 | Mg, Si, Al | 0.050 | 85 | 100 | 4.0 |
| 107 | 1.0 | 4 | 60 | 1.5 | Mg, Si, Al | 0.050 | 85 | 105 | 4.0 |
| 108 | 1.0 | 4 | 60 | 1.5 | Mg, Si, Al | 0.050 | 85 | 90 | 0.5 |
| 109 | 1.0 | 4 | 60 | 1.5 | Mg, Si, Al | 0.050 | 85 | 90 | 1.0 |
| 110 | 1.0 | 4 | 60 | 1.5 | Mg, Si, Al | 0.050 | 85 | 90 | 8.0 |
| 111 | 1.0 | 4 | 60 | 1.5 | Mg, Si, Al | 0.050 | 85 | 90 | 15.0 |
| 112 | 1.0 | 4 | 60 | 1.5 | Mg, Si, Al | 0.050 | 85 | 90 | 20.0 |
| 113 | 1.0 | 4 | 60 | 1.5 | Mg, Si, Al | 0.050 | 85 | 90 | 25.0 |

TABLE 6

| | Magnetic Characteristics | | | |
|---|---|---|---|---|
| | Magnetic Flux | Iron | | |
| | Density | Loss | Insulating | |
| | B8 | W17/50 | Coating | |
| No. | T | W/kg | Adhesion | Note |
| 101 | 1.92 | 0.76 | G | Comparative Example |
| 102 | 1.92 | 0.72 | G | Example |
| 103 | 1.92 | 0.70 | G | Example |
| 104 | 1.92 | 0.68 | G | Example |
| 105 | 1.92 | 0.70 | G | Example |
| 106 | 1.92 | 0.72 | G | Example |
| 107 | 1.92 | 0.76 | G | Comparative Example |
| 108 | 1.91 | 0.74 | G | Comparative Example |
| 109 | 1.92 | 0.72 | G | Example |
| 110 | 1.92 | 0.69 | G | Example |
| 111 | 1.92 | 0.70 | G | Example |
| 112 | 1.92 | 0.72 | G | Example |
| 113 | 1.93 | 0.76 | G | Comparative Example |

It can be seen from Tables 4 to 6 that when the laser irradiation conditions are outside the range of the present invention, sufficiently low iron loss cannot be obtained.

### INDUSTRIAL APPLICABILITY

According to the present invention, a grain-oriented electrical steel sheet having excellent magnetic characteristics and a manufacturing method therefor can be provided. Therefore, industrial applicability is high.

### REFERENCE SIGNS LIST

1 Grain-oriented electrical steel sheet
11 Silicon steel sheet
21 Oxide layer
31 Insulating coating layer
101 Oxide grains
102 Flat grain

1. A grain-oriented electrical steel sheet comprising:
a silicon steel sheet;
an oxide layer formed of one or more kinds of Mg, Al, and Si that is formed on a surface of the silicon steel sheet; and
an insulating coating layer that is formed on a surface of the oxide layer,
wherein an oxide of one or more kinds of Mg, Al, and Si having an equivalent circle diameter of 0.1 to 3.0 μm is present at a density of 0.010 to 0.200 grains/μm² in a range of 5 μm in a sheet thickness direction from an interface between the silicon steel sheet and the oxide layer in the silicon steel sheet,
on the surface side of the silicon steel sheet, flat grains where an average thickness in a direction perpendicular to the surface is 0.5 to 5.0 μm, an aspect ratio that is a ratio of a grain width in a direction parallel to the surface to the average thickness is 1.5 or more, and a deviation of a crystal orientation from Goss orientation is 10° or more are present,
in a cross section in the sheet thickness direction, a length of grain boundaries of the flat grains accounts for 50% or more of a length of the interface between the silicon steel sheet and the oxide layer, and
a plurality of linear thermal strains extending in a direction having an angle of 80 to 100° with respect to a rolling direction are formed on the surface of the silicon steel sheet at intervals of 1.0 to 20.0 mm in the rolling direction.

2. The grain-oriented electrical steel sheet according to claim 1,
wherein an average of the average thicknesses of the flat grains is 0.5 to 2.0 μm.

3. The grain-oriented electrical steel sheet according to claim 1,
wherein a coverage of the oxide layer on surfaces of the flat grains forming the interface is 50% or more.

4. A manufacturing method for a grain-oriented electrical steel sheet, the manufacturing method comprising:
a hot rolling step of heating and hot rolling a slab to obtain a hot rolled sheet;
a hot rolled sheet annealing step of annealing the hot rolled sheet after the hot rolling step;
a pickling step of pickling the hot rolled sheet after the hot rolled sheet annealing step;
a cold rolling step of cold rolling the hot rolled sheet after the pickling step to obtain a cold rolled sheet;
a grinding step of grinding a surface of the cold rolled sheet after the cold rolling step;
a contact step of bringing the cold rolled sheet after the grinding step into contact with an aqueous solution of pH 4.0 to 10.0;
a decarburization annealing step of performing decarburization annealing on the cold rolled sheet after the contact step;
a finish annealing step of applying an annealing separator to the cold rolled sheet after the decarburization annealing step and subsequently performing finish annealing to form an oxide layer formed of one or more kinds of Mg, Al, and Si on a surface of the cold rolled sheet that is a base steel sheet;
an insulating coating forming step of forming an insulating coating layer on a surface of the oxide layer after the finish annealing step to obtain a grain-oriented electrical steel sheet including the silicon steel sheet, the oxide layer, and the insulating coating layer; and
a magnetic domain control step of irradiating a surface of the grain-oriented electrical steel sheet after the insulating coating forming step with a laser, an electron beam, or a plasma to form a plurality of linear thermal strains extending in a direction having an angle of 80 to 100° with respect to a rolling direction on the surface of the silicon steel sheet such that each of intervals in the rolling direction is 1.0 to 20.0 mm,
wherein in the grinding step, using abrasive grains having a Knoop hardness of 1000 or more or using abrasive paper, a roll, or a brush to which the abrasive grains are fixed, the surface of the cold rolled sheet is ground such that an amount of abrasion on at least one surface of the cold rolled sheet is 0.10 to 3.00 g/m².

5. The grain-oriented electrical steel sheet according to claim 2,
wherein a coverage of the oxide layer on surfaces of the flat grains forming the interface is 50% or more.
